(19) United States
(12) Patent Application Publication
(10) Pub. No.: US 2009/0211111 A1
(43) Pub. Date: Aug. 27, 2009

(54) DRYER

(75) Inventors: Yang Ho Kim, Gyeongsangnam-do (KR); Dae Rae Lee, Gyeongsangnam-do (KR); Jung Wan Ryu, Gyeongsangnam-do (KR); Young Soo Kim, Gyeongsangnam-do (KR)

Correspondence Address: BIRCH STEWART KOLASCH & BIRCH, PO BOX 747, FALLS CHURCH, VA, 22040-0747, US

(73) Assignee: LG Electronic Inc., Seoul (KR)

(21) Appl. No.: 12/158,267

(22) PCT Filed: Jan. 3, 2007
(86) PCT No.: PCT/KR2007/000027

§ 371 Date: Oct. 29, 2008

(30) Foreign Application Priority Data
Jan. 3, 2006 (KR) 10-2006-0000551
Jan. 3, 2006 (KR) 10-2006-0000553
Jan. 3, 2006 (KR) 10-2006-0000554

(51) Int. Cl. F26B 19/00; D06F 58/00; D06F 58/04

(52) U.S. Cl. 34/526; 34/131; 34/132

(57) ABSTRACT

The present invention relates to a dryer. The dryer in which a drying object is dried with air from a rotating drum, the air having moisture removed therefrom, heated at a heating unit, and supplied to the rotating drum again, wherein a gas burner is used as the heating unit, and the air is heated by heat exchange with exhaust gas heated by the gas burner.

### TECHNICAL FIELD

The present invention relates to dryers, and more particularly, to a dryer in which air that dried a drying object is condensed, heated, and circulated, for saving a maintenance cost.

### BACKGROUND ART

In general, the dryer removes moisture from laundry, such as washed clothes, for drying the laundry.

In the dryers, there are an exhaust type dryer and a condensing type dryer depending on methods for processing humid air formed in a process of drying the drying object. That is, in the exhaust type dryer, the laundry is dried by supplying external air, and the humid air from a rotating drum is discharged to an outside of the dryer, and in the condensing type dryer, the humid air from the rotating drum is condensed at a condenser to remove moisture therefrom, and the air dried thus is supplied to the drum again, to re-circulate the air.

FIG. 1 illustrates a diagram of a related art condensing type dryer, schematically.

Referring to FIG. 1, the related art condensing type dryer is provided with a rotating drum 11 rotatably mounted in a body 10, connected to one side of a motor 17 and a belt 19, and rotated by the motor 17. In a front of the body 10, there is a door 12 mounted to be opened/closed.

The opened front and a rear of the rotating drum 11 are connected with a circulating duct 14. There is a fan 16 on the circulating duct 14 connected to the other side of the motor 17 for circulating the air. Accordingly, the motor 17 not only rotates the rotating drum 11, but also the fan 16, to circulate the air along the circulating duct 14.

In the meantime, the circulating duct 14 in communication with the rotating drum 11 has one end having a filter 22 mounted thereon for filtering foreign matters and so on from air being discharged from the rotating drum 11. Moreover, on the circulating duct 14, there is a condenser 13 for condensing moisture in the air from the rotating drum, to remove the moisture from the air. The moisture removed at the condenser 13 is collected to a holding tank 2 on an outside of the body 10 by a pump 23. The air having the moisture removed therefrom is supplied to the rotating drum again 11 along the circulating duct 14.

In the meantime, the air having the moisture removed therefrom at the condenser 13 is heated at a heating unit 15, and supplied to the rotating drum 11. As the heating unit 15 in the related art, an electric heater, for an example, a coil heater, is employed. Accordingly, the related art dryer heats air directly with the coil heater or the like, and supplies to the rotating drum 11.

However, the related art dryer has a problem in that a maintenance cost is high significantly because the air circulated along the circulating duct and supplied to the rotating drum again is heated by the electric heater. That is, if the user uses the related art dryer, the heating with the electric heater increases the maintenance cost significantly including electric charge.

Moreover, the direct heating with the electric heater, such as the coil heater can heat the air to the rotating drum, not uniformly, but locally. Therefore, the locally heated air fails to heat the drying object in the rotating drum uniformly.

### DISCLOSURE OF INVENTION

### Technical Problem

An object of the present invention devised to solve the problem lies on providing a dryer which can reduce a maintenance cost significantly, and dry a drying object, uniformly.

### Technical Solution

To achieve these objects and other advantages and in accordance with the purpose of the invention, as embodied and broadly described herein, a dryer in which an drying object is dried with air from a rotating drum, the air having moisture removed therefrom, heated at a heating unit, and supplied to the rotating drum again, wherein the heating unit heats the air by heat exchange.

The heating unit may include a heat exchange pipe arranged along a circulating duct connected between an opened front and a rear of the rotating drum, a heating source adjacent to one end of the heat exchanger pipe for supplying hot gas into the heat exchange pipe, and a circulating fan for making the gas in the heat exchange pipe to flow to make heat exchange with the air in the circulating duct possible.

In the meantime, the heat exchange pipe is arranged to surround an outside circumference of the circulating duct, or along an inside of the circulating duct, with opposite ends thereof in communication with an outside of the circulating duct.

In order to enhance heat exchange efficiency, the heat exchange pipe has a bent shape within the circulating duct, or fins along an outside circumference.

In the meantime, the dryer may further include an exhaust gas sensor at the other end of the heat exchange pipe for sensing exhaust gas.

The heating source may be a gas burner.

The gas burner may include a gas nozzle having gas supplied thereto for spraying selectively, a mixing pipe for mixing the gas from the gas nozzle and air, and discharging the mixed gas, and an igniter for igniting the mixed gas from the mixing pipe to form a flame.

The dryer may further includes a guide member mounted to one end of the heat exchange pipe for guiding the flame from the mixing pipe into the heat exchange pipe.

The dryer may further include a sensing member for measuring a voltage of a flame formed in the mixing pipe, and a control unit for controlling the dryer with reference to the voltage of the flame measured at the sensing member.

The control unit stops operation of the dryer is the flame voltage measured thus is below a reference value.

The dryer may further include a flame holder at an end of the mixing pipe.

The flame holder may be detachably mounted to the end of the mixing pipe.

The flame holder may include a front having a plurality of flame holes formed therein, and an extension from the front, the extension having an inside diameter corresponding to the end portion of the mixing pipe.

Preferably, the flame holes are formed along a circumferential direction of the front.

The flame holes may include flame holding holes along the circumferential direction of a center of the front, and main flame holes on an outer side of the flame holding holes along the circumferential direction of the front.

Preferably, the main flame hole has a diameter greater than the flame holding hole.

The mixing pipe may have a projection from the end portion, and the extension may have a guide groove in one side in correspondence to the projection.

The dryer may further includes a filter mounted on the circulating duct for filtering air from the rotating drum, a pressure sensor for sensing a pressure difference between an inside and an outside of the filter, and a control unit for comparing the difference measured at the sensor to a preset reference for controlling the dryer.

The controller may stop operation of the dryer if the difference measured at the pressure sensor is greater than the reference.

Preferably, the control unit controls to stop operation of the dryer if the difference measured at the pressure sensor within a predetermined time period after starting the dryer is greater than the preset reference, and controls to make an air flow rate from the rotating drum constant if the difference measured at the pressure sensor after a predetermined time period from starting of the dryer is greater than the preset reference.

Preferably, the control unit increases a rotating speed of the fan which circulates the air from the rotating drum for making the air flow rate from the rotating drum constant.

The dryer may further includes an informing unit for informing the user that the filter is out of order in a case the difference measured at the sensor is greater than the preset reference.

The control unit controls to inform an out of order of the filter to the user with the informing unit if the difference measured at the sensor is greater than the preset reference.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIG. 1 illustrates a side view of a related art dryer, schematically.

FIG. 2 illustrates a back view of a heating unit in a dryer in accordance with a preferred embodiment of the present invention.

FIG. 3 illustrates a perspective view of the gas burner in FIG. 2.

FIG. 4 illustrates a block diagram of a gas burner in accordance with a preferred embodiment of the present invention, schematically.

FIG. 5 illustrates a graph showing correlation between a flame voltage and an oxygen concentration.

FIG. 6 illustrates a perspective view of the flame holder in FIG. 3.

FIGS. 7 to 9 illustrate side views showing the steps of mounting the flame holder.

FIG. 10 illustrates a block diagram of a pressure sensor in accordance with a preferred embodiment of the present invention, schematically.

### BEST MODE FOR CARRYING OUT THE INVENTION

This application claims the benefit of Korean Patent Applications Nos. 10-2006-551, filed on Jan. 3, 2006, 10-2006-553, filed on Jan. 3, 2006 and 10-2006-554, filed on Jan. 3, 2006, which are hereby incorporated by reference as if fully set forth herein.

Reference will now be made in detail to the preferred embodiments of the present invention, examples of which are illustrated in the accompanying drawings. Wherever possible, the same reference numbers will be used throughout the drawings to refer to the same or like parts.

FIG. 2 illustrates a back view of a heating unit in a dryer in accordance with a preferred embodiment of the present invention, showing a heating unit mounted to a dryer of the present invention. In the meantime, since a rotating drum, a circulating duct, a fan, and a condenser in the dryer of the present invention are similar to ones in the related art dryer, detailed description of which will be omitted.

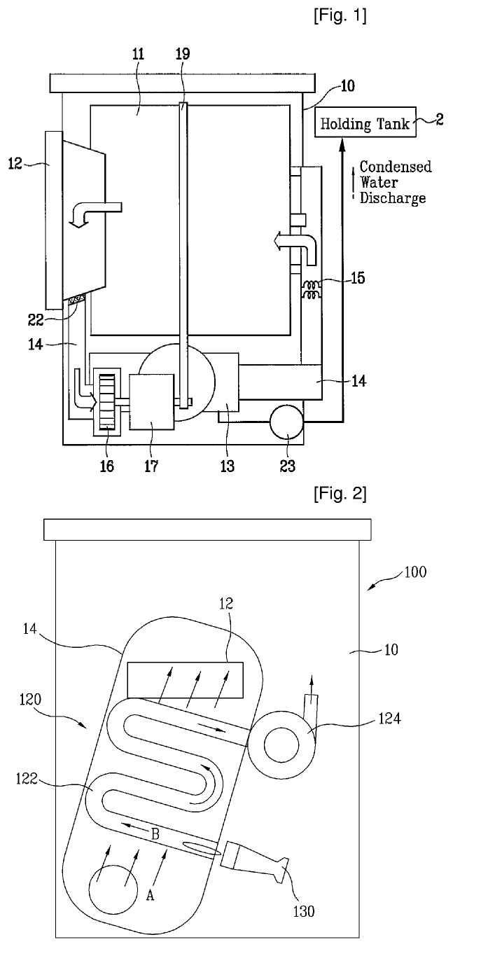

Referring to FIG. 2, the heating unit 120 for heating air being supplied to the rotating drum 11 (see FIG. 1) in the dryer 100 of the present invention includes a heat exchange pipe 122 arranged along the circulating duct 14, a heating source 130 for supplying hot gas to the heat exchange pipe 122, and a circulating fan 124 for making the gas in the heat exchange pipe to flow.

The heat exchange pipe 122 is arranged along the circulating duct 14 for making heat exchange with air circulating along the circulating duct 14 so as to be supplied to the rotating drum 11, to heat the air. Though the heat exchange pipe 122 may be arranged to surround an outside circumference of the circulating duct 144 for enabling the heat exchange, it is preferable that the heat exchange pipe 122 is arranged along an inside of the circulating duct 14, for improving heat exchange efficiency. In this instance, both ends of the heat exchange pipe 122 are made to be in communication with an outside of the heat exchange pipe 122 for preventing exhaust gas in the heat exchange pipe 122 from entering into the rotating drum 11.

In the meantime, as shown, it is preferable that the heat exchange pipe 122 is bent repeatedly for smoother heat exchange with the air flowing along the circulating duct 14. This shape increases a contact area between the air flowing along the circulating duct 14 and the heat exchange pipe 122, to accelerate heat exchange between the heat exchange pipe 122 and the air. Moreover, the shape of the heat exchange pipe 122 is not limited to above shape, but, for an example, fins (not shown) may be formed along an outside circumference of the pipe, for further acceleration of the heat exchange.

Preferably, the heating source 130 in the heating unit 120 is a gas burner. The gas burner 130 is mounted adjacent to one end of the heat exchange pipe 122 for supplying hot exhaust gas into the heat exchange pipe 122. The gas burner 130 has gas supplied thereto from an outside of the dryer, or a tank (not shown) provided to the body 10 separately, for heating the air, which will be described in detail, later.

In the meantime, the circulating fan 124 may be mounted to the other end of the heat exchange pipe 122, for making the hot exhaust gas to flow through the heat exchange pipe 122. That is, the hot exhaust gas is supplied to the one end of the heat exchange pipe 122 by the gas burner 130, and the exhaust gas is made to flow in an arrow B direction by the circulating fan 124, to discharge the exhaust gas through the other end of the heat exchange pipe 122.

In this case, dry air having moisture removed therefrom at the condenser 13 (see FIG. 1) along the circulating duct 14 flows along an arrow A to make heat exchange with the hot exhaust gas in the heat exchange pipe 122 so as to be heated and introduced into the rotating drum 11 through hot air supply opening in communication with the rotating drum 11.

In the meantime, there may be an exhaust gas detector (not shown) at the other end of the heat exchange pipe 122 for sensing a quality of the exhaust gas. The exhaust gas detector senses substances harmful to human body, such as carbon mono-oxide CO, from the exhaust gas from the other end of the heat exchange pipe 122.

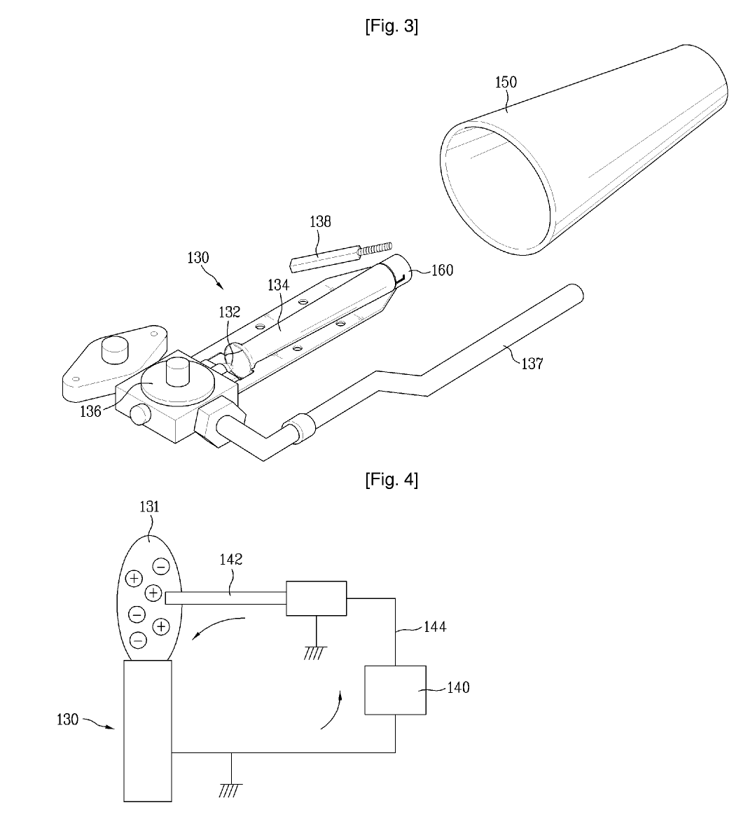

FIG. 3 illustrates a gas burner which serves as a heating source in the heating unit 120 of the present invention.

Referring to FIG. 3, the gas burner 130 includes a gas nozzle 132 for spraying the gas, a mixing pipe 134 for mixing the gas from the gas nozzle 132 with air, to discharge mixed gas, and igniter 138 for igniting the mixed gas from the mixing pipe 134.

The gas nozzle 132 has the gas supplied thereto from an outside of the dryer or the tank (not shown) in the body 10 (see FIG. 2) through a gas pipe 137 for spraying the gas. The gas pipe 137 and the gas nozzle 132 are connected with a gas valve 136 for spraying the gas through the gas nozzle 132 selectively by regulating the gas valve 136.

The gas from the gas nozzle 132 is mixed at, and discharged from, the mixing pipe 134. In detail, the mixing pipe 134 has a shape in which a diameter thereof becomes the smaller as the mixing pipe 134 goes from one end thereof adjacent to the gas nozzle 132 toward the other end thereof the more until the diameter becomes the greater again as the mixing pipe 134 goes to the other end the more. Therefore, when the gas from the gas nozzle 132 is introduced into the mixing pipe 134, the gas is involved in a pressure drop at a portion of the mixing pipe 134 where the diameter of the mixing pipe 134 becomes smaller, to draw air from around the mixing pipe 134 to make the gas mixed with the air. The mixed gas mixed thus is discharged through the other end of the mixing pipe 134, and ignited by the igniter 138, to form a flame.

In the meantime, it is preferable that, at the other end of the mixing pipe 134, there is a flame holder (or stabilizer) 160 for maintaining a stable flame. The flame holder 160 stabilizes the flame at the other end of the mixing pipe 134 to supply the exhaust gas into the heat exchange pipe 122 (see FIG. 2), which will be described in detail, later.

Moreover, it is preferable that there is a guide member 150 at one end of the heat exchange pipe 122. Preferably, the guide member 150 has a shape in which a diameter thereof becomes the smaller, to guide the flame from the mixing pipe 134 into the heat exchange pipe 122. Because the flame is directed from the other end of the mixing pipe 134 toward the heat exchange pipe 122 by the guide member 150, the hot exhaust gas can be supplied to an inside of the heat exchange pipe 122, smoothly.

FIG. 4 illustrates a block diagram of a system for controlling the gas burner 130 in accordance with a preferred embodiment of the present invention, schematically.

Referring to FIG. 4, the dryer of the present invention includes a sensing member 142 mounted adjacent to the flame 131 produced from the gas burner 130 for sensing a voltage of the flame, and a control unit 140 for controlling operation of the dryer according to the voltage of the flame sensed at the sensing member 142.

In detail, the sensing member 142 has one end secured to a position adjacent to an igniting portion of the gas burner 130, and the other end extended to a flame 131 producing position. The sensing member 142 is in contact with the flame to sense the voltage of the flame in a case the flame 131 is produced as the gas burner 130 is operated. It is preferable that the sensing member 142 is formed of metal for sensing the flame voltage. That is, because the flame 131 of the gas burner 130 is conductive, the sensing of the flame voltage is possible by means of the conductive sensing member 142. In the meantime, the sensing member 142 is connected to the control unit 140 with a lead wire 144, for transmitting the flame voltage sensed thus to the control unit 140.

The control unit 140 has a circuit connected to the sensing member 142 and the gas burner 63 with the lead wire 144. As described before, the control unit 140 has the voltage of the flame 131 of the gas burner 130 transmitted thereto by means of the sensing member 142. Therefore, by comparing a voltage in a state the gas burner 130 is not ignited yet to a voltage in a state the gas burner 130 is ignited, the control unit 140 enables control, such as turning off of the dryer in a case the gas burner 130 malfunctions.

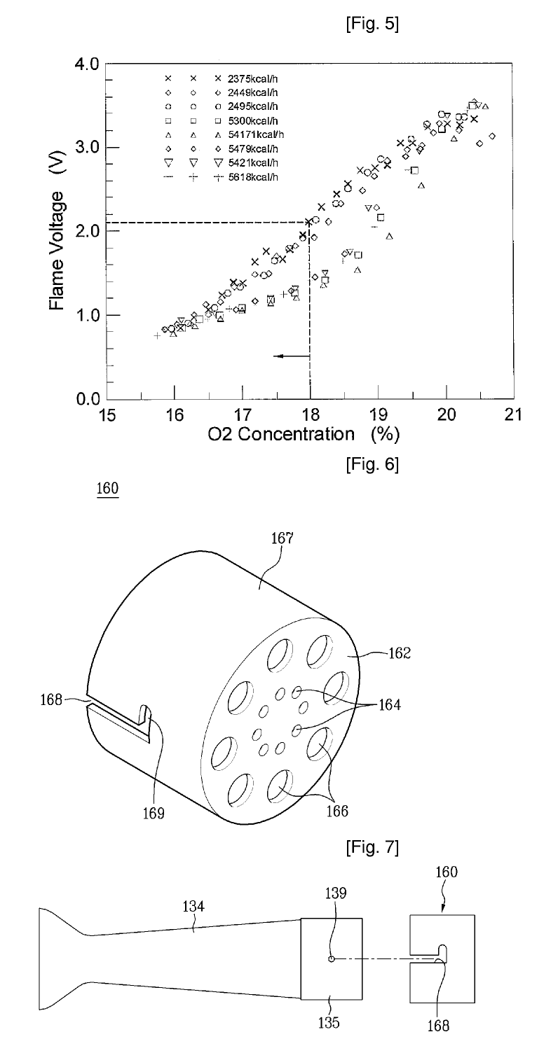

In the meantime, preferably, the control unit 140 has a data of correlation between a variation of oxygen concentration of air of a room the dryer is installed therein and the flame voltage of the gas burner 130 loaded therein in advance. FIG. 5 illustrates a graph showing correlation between a flame voltage and an oxygen concentration tested by the inventor.

Referring to FIG. 5, if the oxygen concentration of air in a closed room drops below 18%, the flame voltage drops below approx. 2.1V. The reference of the oxygen concentration 18% in air is an oxygen concentration which permits a user to breathe in the room safely.

Accordingly, the control unit 140 of the present invention has the flame voltage at which the oxygen concentration of air becomes below 18%, for an example 2.1V, preset therein as a reference. According to this, if the dryer of the present invention is driven, the sensing member 142 senses the flame voltage of the flame at the gas burner 130, and transmits to the control unit 140, and the control unit 140 compares the voltage sensed thus to the preset reference, to control the dryer.

In detail, if the sensed voltage is determined to be below the preset reference, the control unit 140 determines that the oxygen concentration of the room air is below 18%, and controls to stop the dryer. Accordingly, the user can breathe safely in the room, and if the oxygen concentration rises above 18% after a certain time period passes, the dryer is put into operation again manually, or automatically by the control unit. Therefore, even if the exhaust gas is leaked from the gas burner 130 into the room, gas hazard to the user caused by leakage of the exhaust gas into a close space can be solved.

FIG. 6 illustrates a perspective view of the flame holder 160 at the other end of the mixing pipe 134 in FIG. 3.

Referring to FIG. 6, the flame holder 160 includes a front 162 having a plurality of flame holes 164, and 166, and an extension 167 from the front 162.

Preferably, a plurality of the flame holes 164, and 166 are formed along a circumferential direction in two kinds. That is, in the flame holes, there are flame holding holes 164 formed along the circumferential direction at a center portion of a front 162, and main flame holes 166 formed along the circumferential direction of the front 162 on an outer side of the flame holding holes 164.

In detail, the flame holding holes 162 are arranged on a circle at a comparatively center portion of the front for stabilizing a plurality of flames, and the main flame holes 166 formed concentric with an arrangement of the flame holding holes 164 on the outer side thereof form main flames.

It is preferable that the main flame hole 166 has a diameter greater than the flame holding hole 164. That is, a plurality of the main flame holes 166 having the same diameters are arranged on a circle on the outer side of the front 162, and, on an inner side thereof, the flame holding holes 164 are arranged having diameters smaller than the main flame holes 166. It is preferable that the plurality of holes of the main flame holes 166 and the flame holding holes 164 have the same diameters.

Thus, the main flame holes 166 in the flame holder 160 make a flame split into a plurality of short flames. By making the flame short, overheating of the guide member 150 (see FIG. 3) and the heat exchange pipe 122 (see FIG. 2) can be prevented. On the other hand, the flame holding holes 164 prevents flame lifting in which the flame is formed at a positioned excessively far from an outlet of the mixing pipe 134 (see FIG. 3) or back fire from taking place, and enables to maintain a stable flame even if there is an adverse external factor, such as a gas pressure drop, or the like.

At the end, since the mixed gas sprayed from the mixing pipe 134 has a speed made to maintain a proper level at the time the mixed gas passes through the main flame holes 166 and the flame holding holes 164, the dryer of the present invention improves an initial ignition capability. Moreover, the plurality of main flames split as the flame passes through the main flame holes 166, enlarging a total surface of the flame, make a smooth supply of air to the main flames, and shortens flame lengths. Furthermore, the flame holding holes 164 serve to hold the main flames. Particularly, by forming the main flame holes 166 on the outer side and the flame holding holes 164 on the inner side, the embodiment is favorable for maintaining the main flame short compared to a case when the main flame is formed at a center portion.

In the meantime, it is preferable that the flame holder 160 is detachably mounted to the outlet of the mixing pipe 134. In detail, in one side of the extension 167 of the flame holder 160, there is a guide groove 168 formed therein, and on one side of an end portion of the mixing pipe 134 having the outlet, there is a projection 139 (see FIG. 7). Particularly, the guide groove 168 has a slot shape for placing the projection 139 therein, and the guide groove 168 has a bent portion 169 of a predetermined length for firm securing of the projection 139.

In the meantime, though the mixing pipe 134 has a diameter enlarged gradually toward the outlet, i.e., is formed as a diffuser shape, in order to improve coupling to, and fitness with the flame holder 160, it is preferable that the end portion at the outlet of the mixing pipe 134 has a straight tube portion 135 (see FIG. 7) having a diameter the same with the flame holder 160 for a length the same with a length of the flame holder 160. This is because coupling of the flame holder 160 to the end portion of the mixing pipe 134 is easier in a case the end portion of the mixing pipe 124 has the straight tube portion than a case the end portion of the mixing pipe 124 has an enlarged tube portion.

FIGS. 7 to 9 illustrate side views showing the steps of detachably mounting the flame holder 160 to the end portion of the mixing pipe 134.

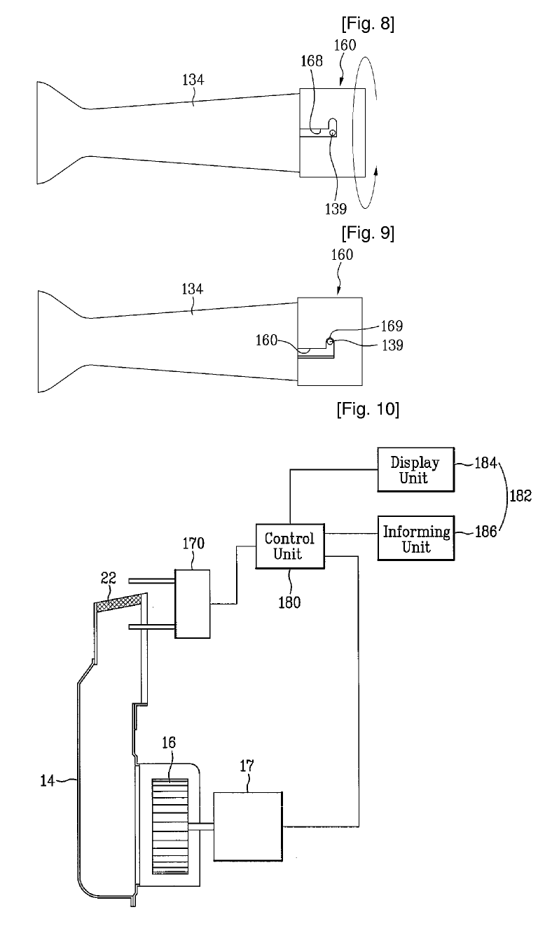

Referring to FIG. 7, if it is intended to mount the flame holder 100 to the mixing pipe 134, the guide groove 168 of the flame holder 160 is brought to the projection 139 of the mixing pipe 134, and, as shown in FIG. 8, the flame holder 160 is pushed into the mixing pipe 134 until the projection 139 is in contact with the bent portion 169 of the guide groove 168. Then, the flame holder 160 is turned in an arrow direction in FIG. 8, so that, as shown in FIG. 9, the projection 139 is held at the bent portion 169 of the guide groove 168.

Opposite to this, if it is intended to remove the flame holder 160 from the mixing pipe 134, it is required to progress the steps opposite to above steps. Eventually, the flame holder 160 of the present invention permits easy coupling/decoupling of the flame holder 160 and the mixing pipe 134 while enhancing coupled force.

FIG. 10 illustrates a filter unit for filtering air from the rotating drum 11 (see FIG. 2) in FIG. 2, schematically.

Referring to FIG. 10, the filter unit includes a filter 22 on the circulating duct 14 for filtering the air from the rotating drum 11, a pressure sensor 170 for sensing a pressure difference between an inside/an outside of the filter 22, and a control unit 180 for comparing the difference measured at the pressure sensor 170 to a preset reference value to control the dryer.

Referring to FIG. 2 again, when the fan 16 is put into operation as the motor is driven, the air in the rotating drum 11 is introduced into the circulating duct 14 and circulates. In this case, the filter 22 is mounted to an inlet to the circulating duct 14 in communication with the rotating drum 11 for filtering various kinds of foreign matters from air from the rotating drum 11.

Referring to FIG. 10 again, once foreign matters are adsorbed to the filter 22 as the dryer is driven continuously, to form a pressure difference between inside and outside of the filter, the pressure difference is sensed by the pressure sensor 170. That is, the pressure sensor 170, mounted to measure pressures on the inside and the outside of the filter 22, senses the pressure difference between the inside and the outside of the filter 22. A value sensed thus is transmitted to the control unit 180.

The control unit 180 receives the pressure difference between the inside and the outside of the filter 22, and determines if the filter 22 is in a workable state or not, i.e., heavy contamination of the filter 22 with the foreign matters, or not.

In the meantime, the control unit 180 has a pressure difference between the inside and the outside of the filter 22 in a case the foreign matters are not adsorbed to the filter 22 to contaminate the filter 22 heavily preset therein in advance as a reference value. Accordingly, the control unit 180 determines that the filter 22 has contaminated with the foreign matters heavily in a case the pressure difference from the pressure sensor 170 is higher than the reference value preset therein.

If it is determined that the filter 22 is contaminated with the foreign matters heavily, the control unit 180 controls operation of the driving motor 17 for driving the fan 16, to control operation of the dryer.

In detail, if it is determined that the filter 22 is contaminated heavily through sensing of pressures on the inside and the outside of the filter 22 at an initial operation stage when a predetermined time period is not passed yet after the dryer is put into operation, for an example, in a case no more than about one minute is passed after the dryer is put into operation, the control unit 180 stops operation of the motor 17, and preferably informs the heavy contamination of the filter 22 to the user through an informing unit 182.

The informing unit 182 includes a display unit 184 for displaying contamination of the filter 22 for the user, preferably, further including an alarm unit 186 for issuing an alarm to the user as shown in the drawing. Accordingly, the user becomes to know the contamination of the filter 22 by the informing unit 182, enabling the user to make maintenance, such as replacement of, the filter 22.

In the meantime, the predetermined time period for determining the initial stage of operation of the dryer is not limited to the one minute described before, but may be varied appropriately depending on a capacity of the dryer, place where the dryer is used, and the like.

In conclusion, the control unit 180 senses a pressure difference between the inside and the outside of the filter 22 at an initial stage of operation of the dryer, and stops the operation of the dryer if the pressure difference exceeds the preset reference value, determining that the filer 22 is blocked. Furthermore, control unit 180 displays a filter replacement message on the display unit 184 and issues an alarm from the alarm unit 186.

In the meantime, in the middle of operation of the dryer having a predetermined time period passed after starting the dryer, for an example, after one minute after the dryer is started, if it is determined that the filter 22 is in a contaminated state through sensing of pressures of the inside/outside of the filter 22, the control unit 180 makes the motor 17 to increase a rotation speed, for making an air flow rate through the filter 22 constant.

That is, if the filter 22 is blocked with the contaminant, with a reduced air flow rate through the filter 22, it becomes difficult to maintain a drying performance of the rotating drum 11 (see FIG. 2). Therefore, if it is determined that the filter 22 is blocked partially in the middle of operation of the dryer, rotation speeds of the motor 17 and the fan 16 are increased, to maintaining the air flow rate through the filter constant without reduction of the air flow rate. According to this, the drying performance can be maintained for a certain time period, and temperature rise of the dryer can be prevented.

Moreover, if it is determined that the filter 22 is heavily contaminated like the initial driving state described before, the control unit 182 puts the informing unit 182 into operation. According to this, the user 22 becomes to know contamination of the filter 22, to enable the user to make a maintenance work, such as replacement of the filter 22, or the like, after finish of drying with the dryer.

In the meantime, though the control unit 180 is shown with a reference numeral different from the control unit 140 in FIG. 4, the control unit in FIG. 4 and the control unit in FIG. 10 may be one control unit.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The application of the gas burner as a heating source for operating the dryer permits to reduce a maintenance cost of the dryer, significantly.

The realtime sensing of the flame voltage, and subsequent stopping of the dryer if the flame voltage is below a preset level, determining that an oxygen concentration of the room is below a reference value, permits to use the dryer even in a closed room by taking safety of the user into account.

The assurance of an adequate air flow rate so as not to cause drop of the air flow rate coming from blocking of a lint filter of the dryer in the middle of operation of the dryer permits to prevent sharp drop of performance in the middle of operation of the dryer.

The splitting of the flame into many smaller flames by means of the flame holder having the plurality of flame holes on the outlet side of the mixing tube, to shorten length of the main flames, permits to make the flame maintained stable. Especially, the arrangement of the main flames on an outer side of the flame holder and the flame holding holes which serve to hold the flame on an inner side thereof makes the main flame shorter, and prevents lifting or forming of the flame from taking place.

The coupling and securing of the flame holder to the mixing pipe by placing the end portion of the flame holder in the mixing pipe and turning the flame holder permits to improve coupling work, and assembly work.

1. A dryer in which an drying object is dried with air from a rotating drum, the air having moisture removed therefrom, heated at a heating unit, and supplied to the rotating drum again, wherein the heating unit heats the air by heat exchange.

2. The dryer as claimed in claim 1, wherein the heating unit includes;
a heat exchange pipe arranged along a circulating duct connected between an opened front and a rear of the rotating drum,
a heating source adjacent to one end of the heat exchanger pipe for supplying hot gas into the heat exchange pipe, and
a circulating fan for making the gas in the heat exchange pipe to flow to make heat exchange with the air in the circulating duct possible.

3. The dryer as claimed in claim 2, wherein the heat exchange pipe is arranged to surround an outside circumference of the circulating duct.

4. The dryer as claimed in claim 2, wherein the heat exchange pipe is arranged along an inside of the circulating duct, with opposite ends thereof in communication with an outside of the circulating duct.

5. The dryer as claimed in claim 4, wherein the heat exchange pipe has a bent shape within the circulating duct.

6. The dryer as claimed in claim 4, wherein the heat exchange pipe has fins along an outside circumference.

7. The dryer as claimed in claim 2, further comprising an exhaust gas sensor at the other end of the heat exchange pipe for sensing exhaust gas.

8. The dryer as claimed in claim 2, wherein the heating source is a gas burner.

9. The dryer as claimed in claim 8, wherein the gas burner includes;
a gas nozzle having gas supplied thereto for spraying selectively,
a mixing pipe for mixing the gas from the gas nozzle and air, and discharging the mixed gas, and
an igniter for igniting the mixed gas from the mixing pipe to form a flame.

10. The dryer as claimed in claim 4, further comprising a guide member mounted to one end of the heat exchange pipe for guiding the flame from the mixing pipe into the heat exchange pipe.

11. The dryer as claimed in claim 9, further comprising a sensing member for measuring a voltage of a flame formed in the mixing pipe, and a control unit for controlling the dryer with reference to the voltage of the flame measured at the sensing member.

12. The dryer as claimed in claim 11, wherein the control unit stops operation of the dryer is the flame voltage measured thus is below a reference value.

13. The dryer as claimed in claim 9, further comprising a flame holder at an end of the mixing pipe.

14. The dryer as claimed in claim 13, wherein the flame holder is detachably mounted to the end of the mixing pipe.

15. The dryer as claimed in claim 13, wherein the flame holder includes;
a front having a plurality of flame holes formed therein, and
an extension from the front, the extension having an inside diameter corresponding to the end portion of the mixing pipe.

16. The dryer as claimed in claim 15, wherein the flame holes are formed along a circumferential direction of the front.

17. The dryer as claimed in claim 15, wherein the flame holes includes;
flame holding holes along the circumferential direction of a center of the front, and
main flame holes on an outer side of the flame holding holes along the circumferential direction of the front.

18. The dryer as claimed in claim 17, wherein the main flame hole has a diameter greater than the flame holding hole.

19. The dryer as claimed in claim 15, wherein the mixing pipe has a projection from the end portion, and
the extension has a guide groove in one side in correspondence to the projection.

20. The dryer as claimed in claim 2, further comprising a filter mounted on the circulating duct for filtering air from the rotating drum,
a pressure sensor for sensing a pressure difference between an inside and an outside of the filter, and
a control unit for comparing the difference measured at the sensor to a preset reference for controlling the dryer.

21. The dryer as claimed in claim 20, wherein the controller stops operation of the dryer if the difference measured at the pressure sensor is greater than the reference.

22. The dryer as claimed in claim 20, wherein the control unit controls to stop operation of the dryer if the difference measured at the pressure sensor within a predetermined time period after starting the dryer is greater than the preset reference, and controls to make an air flow rate from the rotating drum constant if the difference measured at the pressure sensor after a predetermined time period from starting of the dryer is greater than the preset reference.

23. The dryer as claimed in claim 22, wherein the control unit increases a rotating speed of the fan which circulates the air from the rotating drum for making the air flow rate from the rotating drum constant.

24. The dryer as claimed in claim 22, further comprising an informing unit for informing the user that the filter is out of order in a case the difference measured at the sensor is greater than the preset reference.

25. The dryer as claimed in claim 24, wherein the control unit controls to inform an out of order of the filter to the user with the informing unit if the difference measured at the sensor is greater than the preset reference.
